(19) United States
(12) Patent Application Publication
(10) Pub. No.: US 2020/0170327 A1
(43) Pub. Date: Jun. 4, 2020

(54) BI-STABLE BUCKLE

(71) Applicant: Facebook Technologies, LLC, Menlo Park, CA (US)

(72) Inventor: Phillip Yee, San Francisco, CA (US)

(21) Appl. No.: 15/615,349

(22) Filed: Jun. 6, 2017

(51) Int. Cl. A42B 1/22; A44B 11/00; G02B 27/01

(52) U.S. Cl. CPC A42B 1/22; A44B 11/005; G02B 27/0176; A44B 11/00; A44B 11/006; A44B 11/008; G02B 27/017

(57) ABSTRACT

An adjustable buckle secures a head strap to a head-mounted display and is operable between a first stable mode and a second stable mode in which the adjustable buckle transitions between a shorter and a longer effective length to adjust the fit of the head strap according to a wearer's preference. The adjustable buckle comprises a first plate, a second plate, a third plate, and a fourth plate. The first plate secures to the head strap, and the second plate secures to the head-mounted display. The third and fourth plates are bendably connected between the first and second plates via flexible hinges. The second plate is slidably movable along guide member(s) extending between the first and second plates. Rotation of the fourth plate about its flexible hinges causes corresponding translation of the second plate along the guide member(s), placing the adjustable buckle in the first or second stable mode.

### BACKGROUND

The disclosure relates generally to a buckle strap, and more specifically to an adjustable buckle for a head-mounted display.

A head-mounted display typically includes one or more electronic displays that are placed in front of a user's eyes, and the head-mounted display is secured to the user's head via a head strap. As an example, a head-mounted display may be worn by a user in a virtual reality environment, in which the user actively engages with the surrounding environment by moving throughout a local area. Since a user may be moving constantly or sporadically, it is desirable for a user to have a comfortable and well-fitting head-mounted display. As such, there is a need for a head-mounted display that is able to accommodate for a user's preferences for the fit of the head strap.

### SUMMARY

Embodiments relate to an adjustable buckle that is operable between a first stable mode and a second stable mode in which the adjustable buckle has a shorter effective length than when in the first stable mode. The adjustable buckle may include a first plate, a second plate, a third plate, and a fourth plate. The first plate is secured to a portion of a head strap, and the second plate is secured to a head-mounted display. At least one guide member extends between the first plate and the second plate, and the second plate is slidably movable along the guide member to place the adjustable buckle in a first stable mode or to place the adjustable buckle in a second stable mode. A third plate is bendably connected to the first plate or the second plate via a first flexible hinge at a first end. A fourth plate is linked between the third plate and the second plate or the first plate. A first end of the fourth plate is bendably connected to a second end of the third plate via a second flexible hinge and a second end bendably connected via a third flexible hinge to the second plate or the first plate. In the first stable mode, the surface of the fourth plate comes into contact with the second plate or the first plate, and in the second stable mode, a surface of the fourth plate comes into contact with the third plate. In the first stable mode, the adjustable buckle has a longer effective length than in the second stable mode. A user may choose the first stable mode or the second stable mode depending on the desired fit of the head strap on the user's head.

### BRIEF DESCRIPTION OF THE DRAWINGS

Figure (FIG. 1 is a perspective view illustrating a head-mounted display (HMD), according to an embodiment.

FIG. 2A is a perspective view of a buckle assembled onto the HMD of FIG. 1, according to an embodiment.

FIG. 2B is a perspective view illustrating the internal structure of the buckle of FIG. 2A, according to an embodiment.

FIGS. 3A, 3B, and 3C illustrates the buckle of FIG. 2A in a shortened mode, a transitional mode, and an elongated mode, respectively, according to an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

An adjustable buckle securing a head strap to a head-mounted display is operable between a first stable mode and a second stable mode in which the adjustable buckle transitions between a shorter effective length and a longer effective length to adjust the fit of the head strap according to a user's preference. The adjustable buckle comprises a first plate, a second plate, a third plate, and a fourth plate. The first plate secures to the head strap, and the second plate secures to the head-mounted display. The third plate is bendably connected between the second plate and the fourth plate via a flexible hinge at each connecting edge, while the fourth plate is bendably connected between the first plate and the third plate via a flexible hinge at each connecting edge. The second plate is slidably movable along guide member(s) that extend between the first plate and the second plate. The fourth plate includes one or more tabs that a user may pull on in a direction away from the head-mounted display. Pulling on the tabs of the fourth plate causes rotation of the third plate about its flexible hinges, which causes corresponding translation of the second plate along the guide member(s) to place the adjustable buckle in the first stable mode or the second stable mode.

FIG. 1 is a perspective view illustrating a head-mounted display (HMD) 100, according to an embodiment. The HMD 100 may be part of, e.g., a virtual reality (VR) system environment, in which the HMD 100 presents content to a user. Example content includes images, video, audio, or some combination thereof. Audio content may be presented via a separate device (e.g., speakers and/or headphones) external to the HMD 100 that receives audio information from HMD 100, a virtual reality (VR) console, or both. In some embodiments, the HMD 100 may also or alternatively act as an augmented reality (AR) and/or mixed reality (MR) HMD. In these embodiments, the HMD 100 augments views of a physical, real-world environment with computer-generated elements (e.g., images, video, sound, etc.). In the embodiment of FIG. 1, the HMD 100 includes a front rigid body 105, a head strap 110, and a buckle 115.

The front rigid body 105 includes one or more electronic display elements (not shown in FIG. 1) that display images to the user wearing the HMD 100. The electronic display displays images to the user in accordance with data received from a system console (not shown in FIG. 1). In various embodiments, the electronic display may include a single electronic display or multiple electronic displays (e.g., a display for each eye of a user). Examples of the electronic display include: a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, some other display, a projector, or some combination thereof.

In the embodiment of FIG. 1, the front rigid body 105 is positioned against a user's face at eye-level. In some embodiments, the front rigid body 105 includes a face cushion around an outer edge of the front rigid body 105 that may provide a comfortable fit and may better conform to the user's face. Embodiments of the front rigid body 105 for virtual, augmented, or mixed reality may additionally include one or more integrated eye tracking systems, an inertial measurement unit (IMU), one or more position sensors, and/or a depth camera assembly that allow a corresponding system to generate and present content to a user that the user may interact with.

The head strap 110 secures the HMD 100 to a user's head and helps position the front rigid body 105 on a user's face. In the embodiment of FIG. 1, the head strap 110 secures the HMD 100 to a user's head by wrapping around the back of the user's head. The head strap 110 may be composed of a durable fabric, such as nylon, polyester, propylene, or other similar material. In some embodiments, the head strap 110 may have elasticity (e.g., elastic nylon) that allows the head strap 110 to stretch or conform to a user's head. The head strap 110 may have a variety of configurations that may provide additional comfort or stability for the user wearing the HMD 100. For example, the head strap 110 may include a cushioned pad along the strap, a split that allows portions of the head strap 110 to effectively triangulate across the back of the user's head, or a slider that allows the length of the head strap 110 to be tightened or loosened.

The buckle 115 attaches the head strap 110 to the front rigid body 105. In the embodiment of FIG. 1, a first portion of the buckle 115 is secured to a side of the front rigid body 105 while a second portion of the buckle 115 is secured to a first end of the head strap 110, thereby coupling the head strap 110 to the front rigid body 105. While only one buckle 115 is shown in FIG. 1, the HMD 100 may include an additional buckle on a second side of the HMD 100 that attaches a second end of the head strap 110 to the HMD 100. In the embodiment of FIG. 1, the buckle 115 may be composed of rigid materials (e.g., metals or hard plastics).

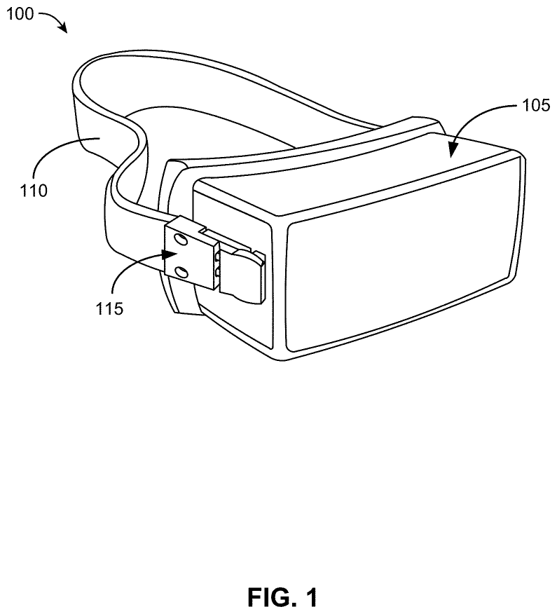

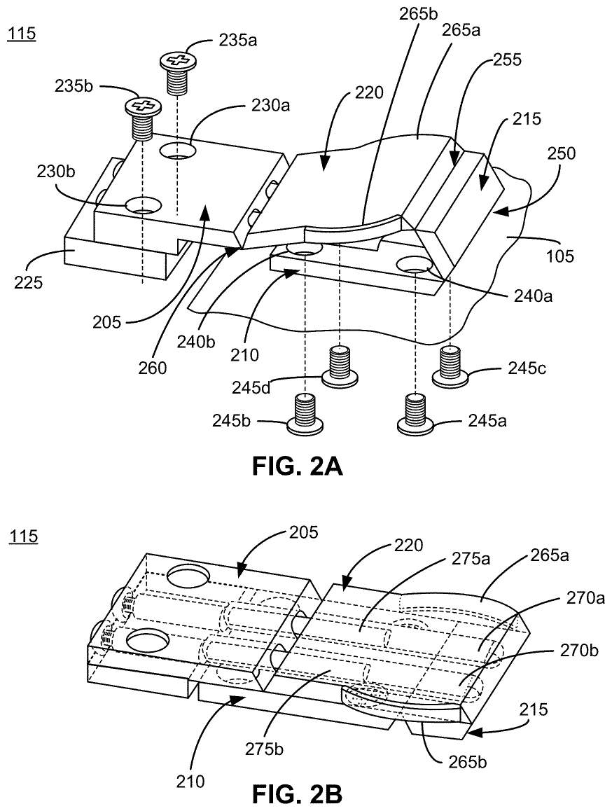

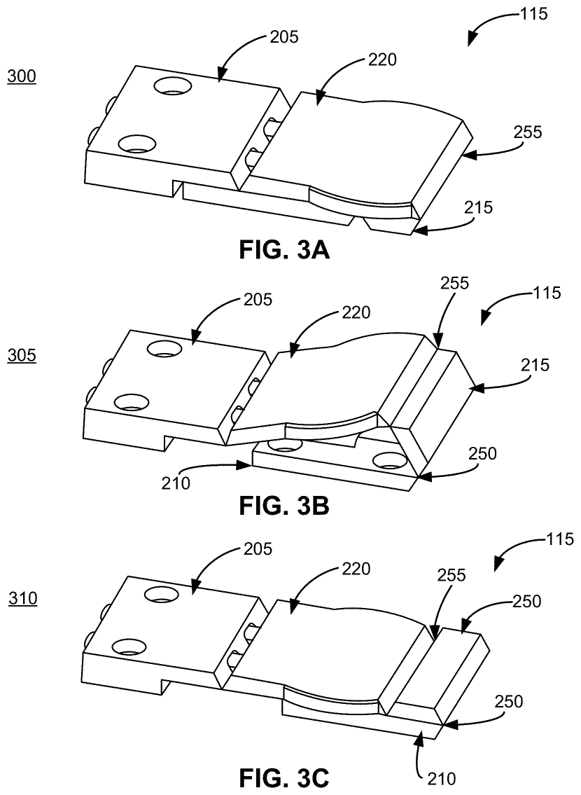

In the embodiment of FIG. 1, the effective length of the buckle 115 is adjustable to loosen or tighten the fit between the front rigid body 105 and the head strap 110 on a user's head. The buckle 115 has a first stable mode in which the effective length of the buckle 115 is shortened (as described below with reference to FIG. 3A) and a second stable mode in which the effective length of the buckle 115 is elongated (as described below with reference to FIG. 3C). The elongated mode may be desirable in certain situations for users (e.g., when a user wears glasses). By elongating the effective length of the buckle 115 and loosening the fit of the head strap 110 around a user's head, additional space is created between a user's face and the front rigid body 105 to, e.g., accommodate a user's glasses. The buckle 115 is capable of transitioning between the shortened and elongated modes, as discussed in greater detail with regards to FIGS. 2 through 3C.

The buckle 115 may additionally be used on various types of eyewear for which it would be desirable to conveniently adjust the effective length of a headstrap of the eyewear. For example, the buckle 115 may be used on sporting goggles (e.g., for swimming, winter sports, biking, etc.) or on safety goggles (e.g., for manufacturing, lab research, aviation, etc.). In some embodiments, the eyewear may have arms that rest over the ears rather than a headstrap (e.g., prescription glasses, sunglasses, safety glasses, etc.). The buckle 115 could be configured to attach an arm to the front body of the eyewear and allow the effective length of each arm or the position of the front body to be adjusted.

FIG. 2A is a perspective view of the buckle 115 assembled onto the HMD 100 of FIG. 1, according to an embodiment. As illustrated in FIG. 2A, a first portion of the buckle 115 secures to the front rigid body 105 while a second portion of the buckle 115 secures to a mounting interface 225 of the head strap 110. In FIG. 2A, the buckle 115 is illustrated in a transitional mode, in which the buckle 115 is in an intermediate position between the shortened mode and the elongated mode. In the embodiment of FIG. 2A, the buckle 115 includes a first plate 205, a second plate 210, a third plate 215, and a fourth plate 220.

The first plate 205 secures the buckle 115 to the head strap 110. The mounting interface 225 is secured to the first plate 205. The mounting interface 225 may be composed of rigid materials (e.g., metals or hard plastics). As illustrated in FIG. 2A, the first plate 205 includes two holes 230a, 230b that may align with corresponding holes (not shown) on the mounting interface 225. Each hole 230a, 230b may have a smooth inner surface for receiving a securing mechanism (e.g., screws 235a, 235b), while each reciprocal hole may have a threaded inner surface for engaging with the securing mechanism. In this configuration, the securing mechanism couples the mounting interface 225 of the head strap 110 and the first plate 205. In the embodiment of FIG. 2A, the holes 230a, 230b are located at opposite edges of the first plate 205 to balance the coupling forces between the mounting interface 225 and the first plate 205. In some embodiments, the mounting interface and the head strap may be integrally formed rather than separate components such that the mounting interface is a continuous portion of the head strap including holes. In some embodiments, the securing mechanism may engage with a fastener having a threaded hole (e.g., nut) to couple the head strap 110 and the first plate 205. The number of holes and respective securing mechanisms for coupling the head strap 110 and the first plate 205 may vary in different embodiments.

The second plate 210 secures the buckle 115 to the front rigid body 105. As illustrated in FIG. 2A, the second plate 210 includes four holes 240a, 240b, 240c, 240d (240c, 240d not shown) that align with corresponding holes (not shown) on the front rigid body 105. Each of the corresponding holes may have a smooth inner surface for receiving a securing mechanism (e.g., screws 245a, 245b, 245c, 245d), while each hole 240 may have a threaded inner surface for engaging with the securing mechanism. In this configuration, the securing mechanism couples the front rigid body 105 and the second plate 210. The number of holes and respective securing mechanisms for coupling the front rigid body 105 and the second plate 210 may vary in different embodiments. In the embodiment of FIG. 2A, the second plate 210 includes four holes 240, one hole near each corner of the second plate 210 to balance the coupling forces between the second plate 210 and the front rigid body 105.

The third plate 215 rotatably connects the second plate 210 to the fourth plate 220. In the embodiment of FIG. 2A, a first edge of the third plate 215 is bendably connected to a first edge of the second plate 210 via a hinge 250. The hinge 250 allows the third plate 215 to rotate relative to the second plate 210, such that the third plate 215 may rotate in a first direction to lie co-planar to the second plate 210 or may rotate in a second direction to lie atop and in contact with a surface of the second plate 210. Similarly, a second edge of the third plate 215 is bendably connected to a first edge of the fourth plate 220 via a hinge 255. The hinge 255 allows the third plate 215 to rotate relative to the fourth plate 220, such that the third plate 215 may rotate in a first direction to lie co-planar to the fourth plate 220 or may rotate in a second direction to lie below the fourth plate 220 such that a surface of the third plate 25 contacts a surface of the fourth plate 220. In the embodiment of FIG. 2A, the hinge 250 and the hinge 255 are living hinges, such that the connected edges of the second plate 210, third plate 215, and fourth plate 220 are integrally formed and have a thin profile that allows the material to bend along the connected edge. In some embodiments, the hinge 250 and the hinge 255 may be a type of mechanical hinge that secures to the plates 210, 215, 220. In this configuration, the third plate 215 may rotate about the hinge 250 and the hinge 255 in a synchronous motion, such that the rotation of the third plate 215 facilitates the transition of the buckle 115 between the shortened mode and the elongated mode, which will be discussed in further detail with regards to FIGS. 3A, 3B, and 3C.

A first edge of the fourth plate 220 is bendably connected to a second edge of the third plate 215 via the hinge 255. In the embodiment of FIG. 2A, the hinge 255 allows the third plate 215 and the fourth plate 220 to rotate relative to each other, such that the plates 215, 220 are co-planar or are in contact with each other. Similarly, a second edge of the fourth plate 220 is bendably connected to a first edge of the first plate 205 via a hinge 260. The hinge 260 allows the fourth plate 220 to rotate relative to the first plate 205, which is connected to the mounting interface 225 of the head strap 110. Similar to hinges 250, 255, the hinge 260 is a living hinge in the embodiment of FIG. 2A. In other embodiments, the hinge 260 may be a type of mechanical hinge.

In the embodiment of FIG. 2A, the fourth plate 220 additionally includes two tabs 265a, 265b, each located along an opposite edge of the fourth plate 220. Each tab 265a, 265b protrudes from an edge of the fourth plate 220 and is substantially dome-shaped. The tabs 265a, 265b allow a user to grasp the fourth plate 220 and pull it in a direction away from an upper side of the front rigid body 105 of the HMD 100. Pulling the fourth plate 220 away from the front rigid body 105 actuates the transition between the shortened mode and the elongated mode of the buckle 115. In some embodiments, the shape of each tab may vary (e.g., square, rectangular, pyramidal, or any other regular or irregular polygonal shape).

FIG. 2B is a perspective view illustrating the internal structure of the buckle 115 of FIG. 2A, according to an embodiment. In FIG. 2B, the buckle 115 is illustrated in the shortened mode where the distance between the first plate 205 and the second plate 210 is shortened. The buckle 115 includes internal components that stabilize the buckle 115 in the shortened mode or the elongated mode. In the embodiment of FIG. 2B, the buckle 115 is formed with two passages 270a, 270b (collectively referred to as “passages 270”) and provided with two alignment pins 275a, 275b (collectively referred to as “alignment pins 275”).

Each passage 270 spans between the first plate 205 and the fourth plate 220. In the embodiment of FIG. 2B, the passages 270 are parallel to each other and are oriented such that each passage 270 extends along the length of the buckle 115. In the embodiment of FIG. 2B, each passage 270 is formed through a portion of the body of the first plate 205 and extends into the body of both the second plate 210 and the fourth plate 220. In some embodiments, each passage 270 may be positioned such that each passage 270 is formed through the first plate 205 and through the body of either the fourth plate 220 or the second plate 210. The length of each passage 270 extends through a portion of the first plate 205 and through a majority of the fourth plate 220. However, the length of each passage may vary in other embodiments. In some embodiments, the length of each passage 270 may extend all the way through the body of the buckle 115.

Housed within each passage 270a, 270b is a respective alignment pin 275a, 275b. The alignment pins 270 are guide members that assist the transition of the buckle 115 between the shortened mode and the elongated mode. In the embodiment of FIG. 2B, a first end of each alignment pin 270 is secured within the first plate 205 to prevent movement of the alignment pin 275 within the passage 265. In other embodiments, the alignment pins 270 may be secured within the second plate 210 or within both the first plate 205 and the second plate 210. Each alignment pin 275 extends long enough into the fourth plate 220 such that a second end of each alignment pin 275 is not displaced from the passage when the buckle 115 is in the elongated mode but short enough such that a surface of the third plate 215 can abut a surface of the second plate 210 when the buckle 115 is in the shortened mode. The alignment pins 275 are dimensioned to be smaller than the inner dimensions of the respective passages 270 to allow for a loose fit or a slip fit between the alignment pins 275 and the passages 270. This configuration allows the fourth plate 220 to glide smoothly across the alignment pins 275 during the transition between the shortened mode and the elongated mode, which will be discussed in further detail with regards to FIGS. 3A, 3B, and 3C. The alignment pins 275 may be composed of a rigid material (e.g., metal or hard plastics). The number of alignment pins 275 and respective passages 270 may vary in other embodiments.

FIGS. 3A, 3B, and 3C illustrates the buckle 115 of FIG. 2A in a shortened mode 300, a transitional mode 305, and an elongated mode 310, respectively, according to an embodiment. As illustrated in FIG. 3A, the buckle 115 is in the shortened mode 300, in which the distance between the first plate 205 and the second plate 210 is reduced, thereby decreasing the effective length of the buckle 115 and tightening the fit between the front rigid body 105 and the head strap 110. As shown in FIG. 3A, the third plate 215 is co-planar with the second plate 210 and a surface of the third plate 215 abuts a surface of the fourth plate 220. To change the mode of the buckle 115, a user pulls on the tabs 265 on the fourth plate 220 to release the buckle 115 from its stable position in the shortened mode 300.

As illustrated in FIG. 3B, the buckle 115 is in the transitional mode 305, in which the buckle 115 can transition back and forth between the shortened mode 300 and the elongated mode 310. In the transitional mode 305, the fourth plate 220 is capable of sliding along the alignment pins 275 while the third plate 215 synchronously rotates about its hinges 250, 255. As the fourth plate 220 slides along the alignment pins 275 from the shortened mode 300, the distance between the first plate 205 and the second plate 210 increases, and the third plate 215 rotates approximately 180 degrees about hinge 250 and approximately 180 degrees about hinge 255. As a result of this motion, the third plate 215 switches from being co-planar with the second plate 210 to being co-planar with the fourth plate 220. As a result, a surface of the third plate 215 abuts a surface of the second plate 210, placing the buckle 115 in the elongated mode 310.

As illustrated in FIG. 3C, the buckle 115 is in the elongated mode 310, in which the distance between the first plate 205 and the second plate 210 is increased, thereby increasing the effective length of the buckle 115 and loosening the fit between the front rigid body 105 and the head strap 110. As shown in FIG. 3C, the third plate 215 is co-planar with the fourth plate 220. The rotational configuration of the third plate 215 allows the third plate 215 to lock in its position when in the shortened mode or in the elongated mode, assisting the buckle 115 in maintaining its stability in either mode. To change the mode of the buckle 115 from the elongated mode 310, in a similar manner as previously described, a user may pull on the tabs 265 on the fourth plate 220 to release the buckle 115 from its stable position, allowing the fourth plate 220 to slide along the alignment pins 275 and transition the buckle 115 into the shortened mode 300.

Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. An adjustable buckle, comprising:
a first plate configured to secure to a portion of a head strap;
a second plate configured to secure to a head-mounted display;
at least one guide member extending between the first plate and the second plate, at least one of the first plate and the second plate slidably movable along the guide member to place the adjustable buckle in a first stable mode or to place the adjustable buckle in a second stable mode, a distance between the first plate and a second plate larger in the first stable mode relative to the second stable mode;
a third plate bendably connected to the first plate or the second plate via a first flexible hinge at a first end; and
a fourth plate between the third plate and the second plate or the first plate, the fourth plate having a first end bendably connected to a second end of the third plate via a second flexible hinge and a second end bendably connected via a third flexible hinge to the second plate or the first plate, a surface of the fourth plate coming into contact with the third plate in the second stable mode, the surface of the fourth plate coming into contact with the second plate or the first plate in the first stable mode.

2. The adjustable buckle of claim 1, wherein the at least one guide member is housed within a passage of the first plate.

3. The adjustable buckle of claim 1, wherein the at least one guide member is secured within the first plate or the second plate.

4. The adjustable buckle of claim 1, wherein the third plate comprises a plurality of protruding tabs.

5. The adjustable buckle of claim 4, wherein when a user exerts a force on the plurality of protruding tabs in a direction away from a side of the head-mounted display to which the adjustable buckle is attached, the adjustable buckle is released from its stable mode.

6. The adjustable buckle of claim 1, wherein the first flexible hinge and the second flexible hinge are configured to rotate at least 180 degrees.

7. The adjustable buckle of claim 1, wherein the third plate slidably moves along the at least one guide member in synchronous motion with rotation of the fourth plate about the second flexible hinge and the third flexible hinge.

8. The adjustable buckle of claim 1, wherein the first plate, second plate, third plate, and fourth plates are integrally formed of the same material.

9. An adjustable buckle for coupling a head strap and a head-mounted display, the adjustable buckle comprising:
a first plate configured to secure a portion of the head strap;
a second plate configured to secure a portion of the head-mounted display;
at least one guide member extending between the first plate and the second plate;
a linked plate between the first plate and the second plate, the linked plate having a first end bendably connected to a second end of the first plate via a first flexible hinge and a second end bendably connected via a second flexible hinge to the second plate, at least a portion of the linked plate positioned along the at least one guide member and slidably movable to place the adjustable buckle in a first stable mode or in a second stable mode, a distance between the first plate and a second plate larger in the first stable mode relative to the second stable mode.

10. The adjustable buckle of claim 1, wherein the at least one guide member is housed within a passage of the first plate.

11. The adjustable buckle of claim 1, wherein the at least one guide member is secured within the first plate or the second plate.

12. The adjustable buckle of claim 1, wherein the linked plate comprises a plurality of protruding tabs.

13. The adjustable buckle of claim 4, wherein when a user exerts a force on the plurality of protruding tabs in a direction away from a side of the head-mounted display to which the adjustable buckle is attached, the adjustable buckle is released from its stable mode.

14. The adjustable buckle of claim 1, wherein the first flexible hinge or the second flexible hinge are configured to rotate at least 180 degrees.

15. The adjustable buckle of claim 1, wherein the linked plate slidably moves along the at least one guide member in synchronous motion with rotation of the linked plate about the second flexible hinge.

16. The adjustable buckle of claim 1, wherein the first plate, second plate, and linked plate are integrally formed of the same material.

17. An eyewear comprising:
a front rigid body;
a head strap; and
an adjustable buckle, comprising:
a first plate configured to secure to a portion of the head strap,
a second plate configured to secure to the front rigid body,
at least one guide member extending between the first plate and the second plate, at least one of the first plate and the second plate slidably movable along the guide member to place the adjustable buckle in a first stable mode or to place the adjustable buckle in a second stable mode, a distance between the first plate and a second plate larger in the first stable mode relative to the second stable mode,
a third plate bendably connected to the first plate or the second plate via a first flexible hinge at a first end, and
a fourth plate between the third plate and the second plate or the first plate, the fourth plate having a first end bendably connected to a second end of the third plate via a second flexible hinge and a second end bendably connected via a third flexible hinge to the second plate or the first plate, a surface of the fourth plate coming into contact with the third plate in the second stable mode, the surface of the fourth plate coming into contact with the second plate or the first plate in the first stable mode.

18. The eyewear of claim 17, wherein the at least one guide member is housed within a passage of the first plate.

19. The eyewear of claim 17, wherein the at least one guide member is secured within the first plate or the second plate.

20. The eyewear of claim 17, wherein the third plate comprises a plurality of protruding tabs.
